(19) United States
(12) Patent Application Publication
(10) Pub. No.: US 2018/0150286 A1
(43) Pub. Date: May 31, 2018

(54) CROSS-MACHINE BUILD SCHEDULING SYSTEM

(71) Applicant: Microsoft Technology Licensing, LLC, Redmond, WA (US)

(72) Inventors: David Speirs, Woodinville, WA (US); Vitaly Rubtsov, Redmond, WA (US); Denise Elisabeth Oquist, Duvall, WA (US); Eli Bristol Davis, Seattle, WA (US); Dineshkumar Srinivasan, Snoqualmie, WA (US); Carlo Rivera, Township of Washington, NJ (US); Pranav Gupta, Seattle, WA (US); Lydia Polyzou, Seattle, WA (US); Xinghua Li, Bellevue, WA (US); Derek Ying Kit Leung, Seattle, WA (US)

(73) Assignee: Microsoft Technology Licensing, LLC, Redmond, WA (US)

(21) Appl. No.: 15/425,834

(22) Filed: Feb. 6, 2017

Related U.S. Application Data
(60) Provisional application No. 62/427,097, filed on Nov. 28, 2016.

(51) Int. Cl. G06F 9/45; G06F 9/44

(52) U.S. Cl. CPC G06F 8/452; G06F 8/35

(57) ABSTRACT

Cross-machine build scheduling of a codebase is provided. Systems, methods and computer-readable devices provide for breaking a monolithic codebase into a plurality of tenants. A file containing entries associated with one of the tenants is read, and a selected entry in the file is examined to determine if the entry is requesting the execution of parallel loop. If so, each loop of the parallel loops is executed in parallel, and the selected entry in the file is examined to determine if the entry is an independent loop. If so, the independent loop is executed, and the selected entry in the file is examined to determine if the entry is a dependent loop. If so, execution of the dependent loop is held.

### RELATED APPLICATION

This application claims benefit of U.S. Provisional Patent Application No. 62/427,097 titled “CROSS-MACHINE BUILD SCHEDULING SYSTEM” filed on Nov. 28, 2016, the entirety of which is hereby incorporated by reference.

### BACKGROUND

When developing a software product, the codebase for the product can be extensive. As such, building, testing, and validating a product can be very time-consuming and challenging. Software products often need to be built on different machines due to constraints on development tools. For example, products for a first type of computing equipment need to be built on a first type of machine, while product for second type of computing product or machine can be built on a second type of product or machine. Furthermore some pieces of code may be built on a first machine and/or perhaps a second machine, while other code may be built in the cloud. According to aspects, such code had to be manually built, copied from machine to machine, and manually verified. In addition, due to dependencies between different portions of the code, when changes to portions of the code were made, manual intervention was required to integrate that code into the whole codebase when integrating among branches.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

Aspects are directed to an automated system, method, and computer storage medium for a cross-machine build scheduling system. Execution of parallel loops, single loops, pre-validation loops, and dependent loops is described. According to aspects, a method breaks a monolithic codebase into a plurality of tenants. The method then reads a file, for example an Extensible Markup Language (XML) file, containing entries associated with one of the tenants. The method next examines a selected entry in the file to determine if the entry is requesting the execution of parallel loops, and if so, executes each loop of the parallel loops in parallel. The method examines the selected entry in the file to determine if the entry is an independent loop, and if so, executes the independent loop. The method also examines the selected entry in the file to determine if the entry is a dependent loop, and if so, holds execution of the dependent loop.

Additional aspects include a method to aggregate builds from a plurality of tenants into a product ready for release. The method separates a codebase into a plurality of tenants. The method reads a list of tenants required to aggregate to form a product release. The method calls up the latest builds of each tenant. The method combines the latest builds into a secure package. The method signs the secure package and publishes the secure package to a common, shared location.

Additional aspects include a method to automatically build source code on appropriate machines. For example, one build may require a build on a first type of machine (e.g., a WINDOWS® operating system (available from Microsoft Corp. of Redmond, Wash.) machine) and a second build may require a build on a second type of machine (e.g., a MACOS® operating system (available from Apple, Inc. of Cupertino, Calif.) machine). The method monitors source code for changes. When changes are found, the method determines an appropriate build machine by determining whether the changes require a build on a first machine with a first operating system or a second machine with a second operating system. The method sends a configuration with the changed source code to the appropriate build machine. The method receives results from the appropriate build machine and reports the results.

Additional aspects disclose a method for conducting a build when cloud-based builds are part of the overall build. The method starts a build. Next, the method determines what portions of the build reside in the cloud and what portions of the build reside locally. The method fetches a current build from the cloud for those portions of the build residing in the cloud. The method synchronizes each of the fetched, current builds with each of the builds that reside locally to form a product build.

Examples are implemented as a method, computer process, a computing system, or as an article of manufacture such as a device, computer program product, or computer readable media. According to an aspect, the computer program product is a computer storage media readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram of an example operating environment comprising a cross-machine build scheduling system;

FIG. 2 is a block diagram illustrating a tenant model;

FIG. 3 is a block diagram illustrating a monolithic codebase segregated into a plurality of tenants;

FIG. 4 is a flow chart showing general stages involved in an example method for tenantizing a codebase;

FIG. 5 is a flow chart showing general stages involved in an example method for multi-loop synchronization;

FIG. 6 is a flow chart showing general stages involved in an example method for click-to-run aggregation;

FIG. 7 is a flow chart showing general stages involved in an example method for external system integration using a local build;

FIG. 8 is a flow chart showing general stages involved in an example method for external system integration using a cloud build;

FIG. 9 is a block diagram illustrating example physical components of a computing device;

FIGS. 10A and 10B are simplified block diagrams of a mobile computing device; and

FIG. 11 is a simplified block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

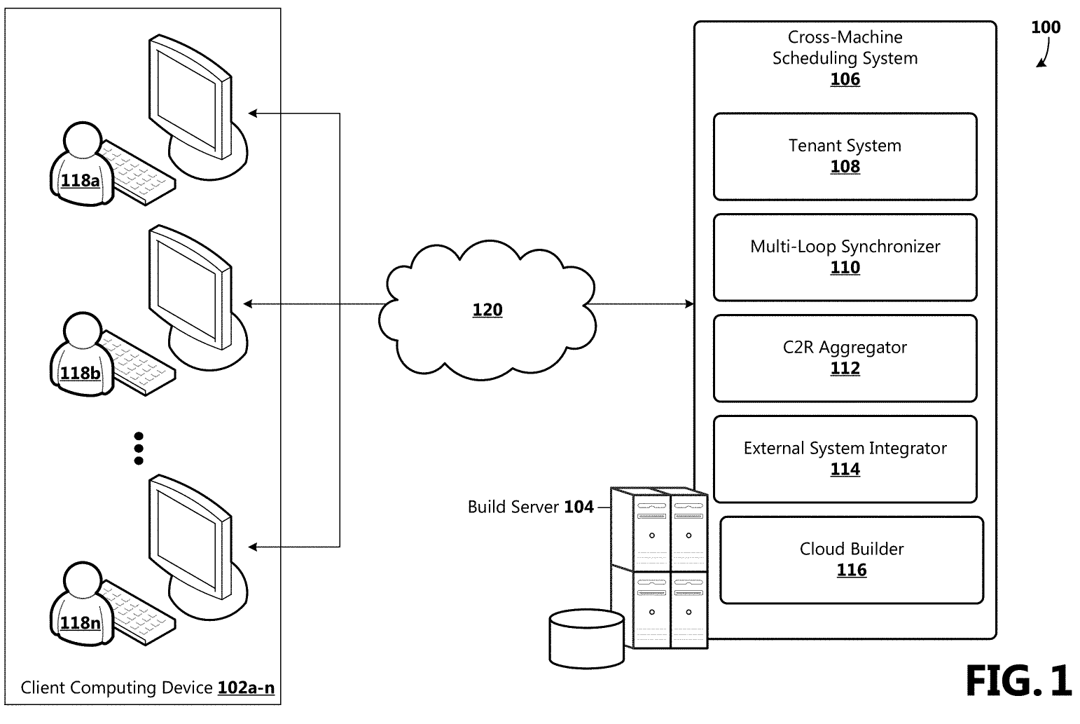

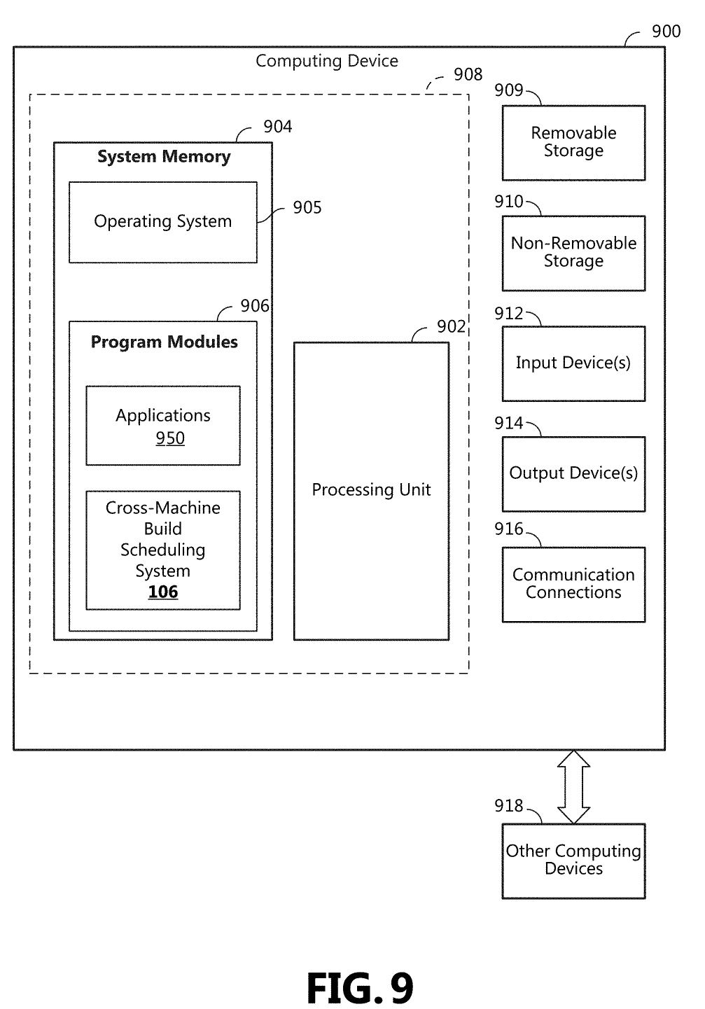

Aspects of the present disclosure are directed to a method, system, and computer storage medium for cross-machine build scheduling. With reference now to FIG. 1, an example operating environment 100 including a cross-machine build scheduling system 106 is shown. The example operating environment 100 includes one or more client computing devices 102a-n (collectively, 102) via which users 118a-n (collectively, 118) (e.g., software developers) can use to write and edit source code that is used to build a particular software system, application, or software component. The client computing devices 102 can be a variety of machines, including machines running the WINDOWS® operating system (available from Microsoft Corp. of Redmond, Wash.), MACOS® operating system (available from Apple, Inc. of Cupertino, Calif.), UNIX® operating system (available from the Open Group of Reading, UK), or represent a computing device in the cloud. The client computing devices 102 are operative to communicate over a network 120, which may include wired or wireless networking, with a build server 104. For example, the build server 104 is illustrative of one or more computing devices operative to compile computer source code into binary code, package binary code, and run automated tests. The hardware of these computing devices is discussed in greater detail in regard to FIGS. 9, 10A, 10B, and 11.

The cross-machine scheduling system 106 is executed on or communicatively connected to the build server 104. According to an aspect, the cross-machine scheduling system 106 comprises a tenant system 108, a multi-loop synchronizer 110, a click-to-run (“C2R”) aggregator 112, an external system integrator 114, and a cloud builder 116.

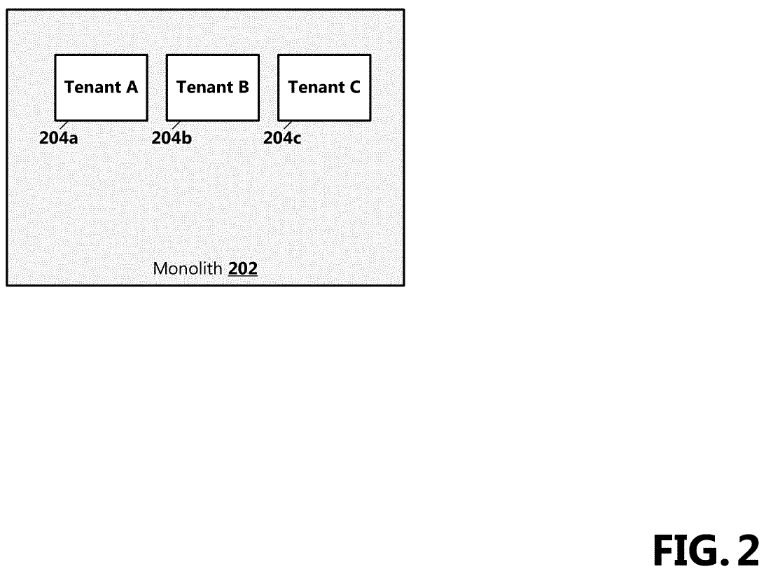

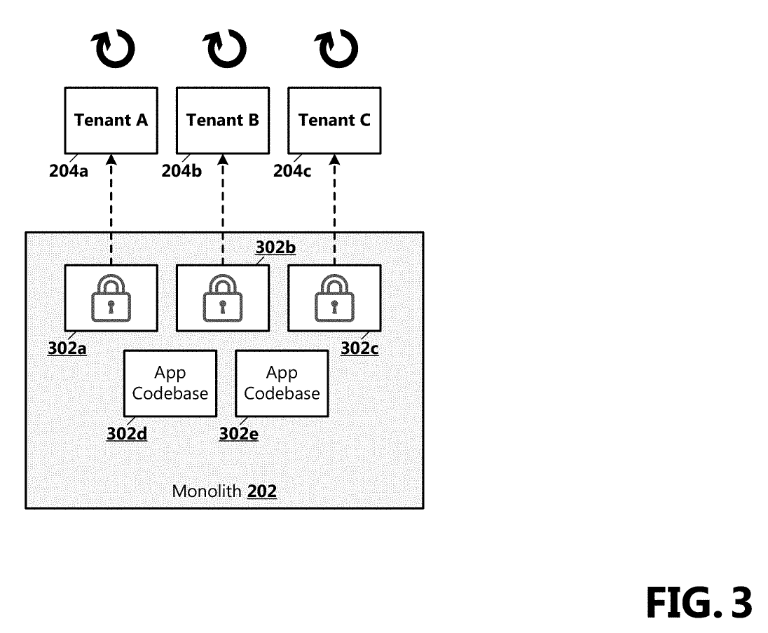

With reference now to FIG. 2, the tenant system 108 is illustrative of a software module, system, or device operative to isolate sections of a monolithic codebase 202 for efficient build and validation. For example and as illustrated in FIG. 3, a monolithic codebase 202 is segregated into a plurality of smaller sections or tenants 204a-c (collectively, 204) such that check-ins either go inside or outside the tenant 204, but generally not both at once. It is possible to override this in special cases and write into both the monolithic codebase 202 and one or more tenants 204, but it rarely, if ever, occurs. According to aspects, tenants 204 can automatically consume newer binary dependencies when available based on a signal, and can submit its own tenant sources to the monolith when validated. For example, upstream dependencies may be consumed via forward integration, and changes may be published back to the monolith 202 via reverse integration. In some examples, different application codebases 302 (FIG. 3) may depend on a single shared library that they all consume. According to an aspect, in a tenant model environment, the different application codebases 302 continue to take the shared component as an input into the system even though they all build individually and separately.

According to an example, in the absence of tenants 204, users 118 work together in one large branch, and all users 118 get builds on a same cadence. The tenant system 108 enables users 118 to check in and verify changes in a shorter time period. For example, if a typical application build in a monolith model environment is on a 36-hour cadence, in a tenant model environment, a turnaround time may include checkpoints every 0.5-3 hours with shippable releases every 3-4 hours. According to an aspect, the tenant system 108 can allow development users 118 or teams to ship independently. For example, if one team wants to ship every three years, and another team wants to ship every day, by breaking the monolithic codebase 202 into smaller pieces or tenants 204, the same code can effectively be released at different rates by mirroring and building it separately and then releasing on its own path.

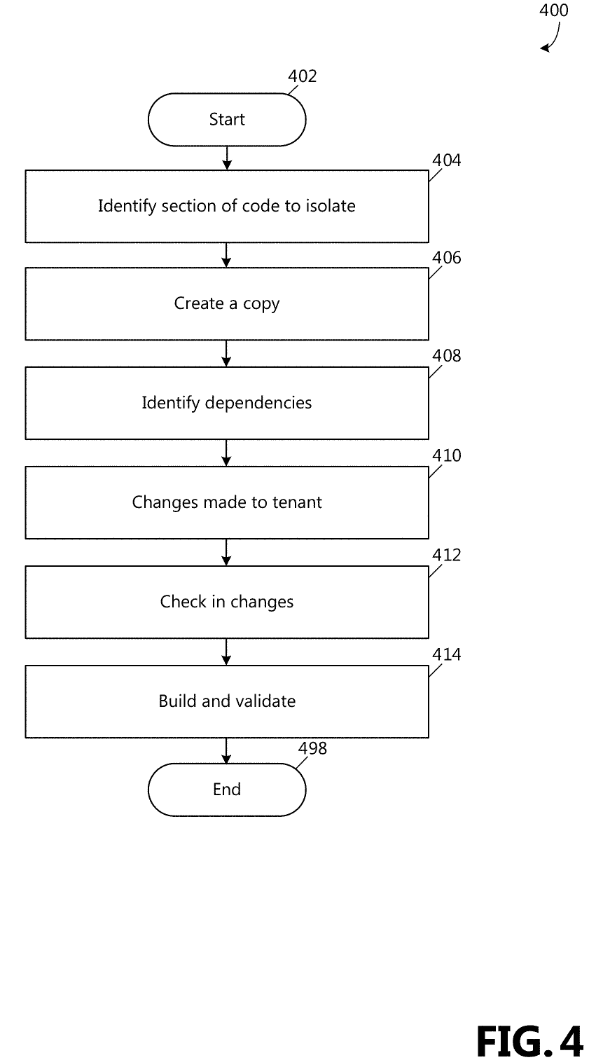

With reference now to FIG. 4, a flowchart showing general stages involved in an example method 400 for tenantizing a monolithic codebase 202 is illustrated. The method 400 starts at OPERATION 402, and proceeds to OPERATION 404, where a section of a monolithic codebase 202 to isolate is identified. At OPERATION 406, the section of code is locked in the main branch, a copy of the code is made, and a tenant 204 is created. The method 400 proceeds to OPERATION 408, where dependencies are identified. At OPERATION 410, changes are made to the tenant 204. At OPERATION 412, the changes are checked in. In some examples, the changes are checked into the copy made of the code. The method 400 proceeds to OPERATION 414, where the changes are built and verified/validated. Each time a user 118 or team does check in, the codebase can be built quickly, and the user 118 is enabled to find out quickly whether the changes pass or fail. In case of a fail, a defined action can be taken as will be described below. The method 400 ends at OPERATION 498.

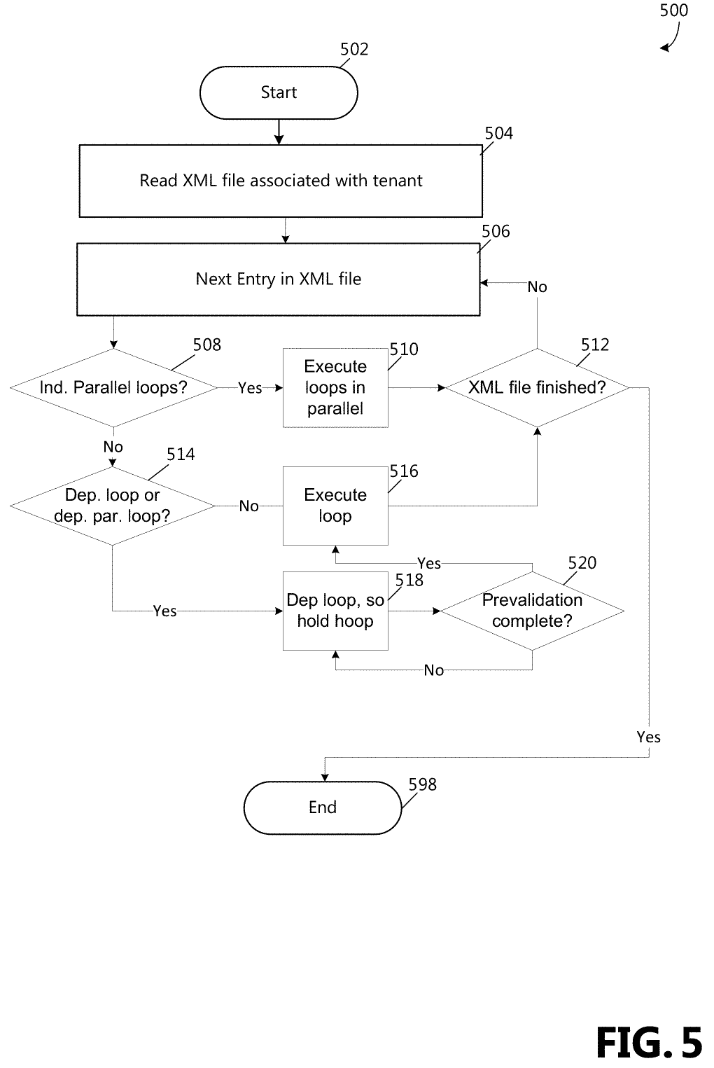

With reference now to FIG. 5, a flowchart showing general stages involved in an example method 500 for multi-loop synchronization 202 is illustrated. As the monolithic codebase 202 is broken down into tenants 204, each tenant 204 can be acted on separately and independently from other tenants 204. For a given tenant 204, the tenant 204 may need multiple builds or slices, for example, a build for X86 architecture, a build for X64 architecture, a build for ARM architecture, a build for Android, a build for debug, a build for testing, and other builds. These builds may occur on local machines or in the cloud (“cloud builds”). Rather than perform each build sequentially, the multi-loop synchronization system allows for parallel loops, so that builds and other loops can be performed in parallel.

The method 500 starts at OPERATION 502 and proceeds to OPERATION 504 where a file, such as an XML file, associated with a tenant 204 is read. The XML file lists loops, with each loop having its own XML file, to be performed on the tenant 204 and dependencies between loops. In particular, various loops may be ordered or dependent on other loops (the other loops being “pre-validation loops”) or certain loops may be performed in parallel (“parallel loops”). For example, an XML file associated with a tenant 204 may specify that loop 1 (build X86 code) and loop 2 (build X64 code) may be run in parallel; loop 3 (test X86 code) cannot run until loop 1 (build X86 code) is completed. Complex dependences may be built among loops.

Timestamps play a role in the multi-loop synchronization. If loop A is a pre-validation loop of loop B, then loop B will use a timestamp of the last successful iteration of loop A. If loop A and loop B are parallel loops, each will build a different slice with the same timestamp and same version number in parallel. These timestamps are used in determining when pre-validation loops have completed and when parallel loops have completed. An exception to the use of timestamps is with cloud builds. When fetching cloud build outputs for a prevalidation loop, the dependent loop may use a changelist hashtag to determine which build to retrieve. Again, the assignment of loops into pre-validation loops or parallel loops is defined in the associated file (e.g., XML file).

The method 500 proceeds to OPERATION 506 where the first entry in the file is initially read. This entry may specify the execution of an independent loop (which may or may not be a pre-validation loop depending upon whether another loop is dependent upon it); execution of parallel loops, or execution of a loop dependent upon a pre-validation loop (a dependent loop). At OPERATION 508, the method 500 checks to see whether the entry is commanding execution of independent parallel loops, which are parallel loops that do not depend upon other loops. If so, at OPERATION 510, the order is given to execute the loops in parallel and when completed timestamped. The method 500 continues at OPERATION 512 to test whether the read file has completely been executed, and if so the method 500 ends at OPERATION 598. If not, the method 500 continues to OPERATION 506 where the next entry in the file is read.

Returning to the discussion of OPERATION 508, if the entry is not for execution of independent parallel loops, the method 500 continues to OPERATION 514 where a test is made to determine if the loop is dependent upon a pre-validation loop. Furthermore, parallel loops may need to wait on specific stages being performed by other parallel loops. For example, loop A may be required to wait for loop B to finish a build stage “abc” before loop A moves on to build step “def.” These are known as “waits” and “waypoints,” and may also be specified in the XML file. If no dependencies or waits are found, the method 500, at OPERATION 516, orders execution of the loop. Following that order, the method 500 continues to test whether execution of the file is finished at OPERATION 512.

Returning to OPERATION 514, if the loop is a dependent loop, i.e., dependent upon a pre-validation loop, the method 500 continues to OPERATION 518 where execution of the loop is put on a hold. The method 500 at OPERATION 520 checks to see whether the pre-validation loop, upon which the dependent loop depends, has completed execution. If not, the hold continues at OPERATION 518. If the pre-validation loop has completed execution, the method proceeds to OPERATION 516 where the loop is executed.

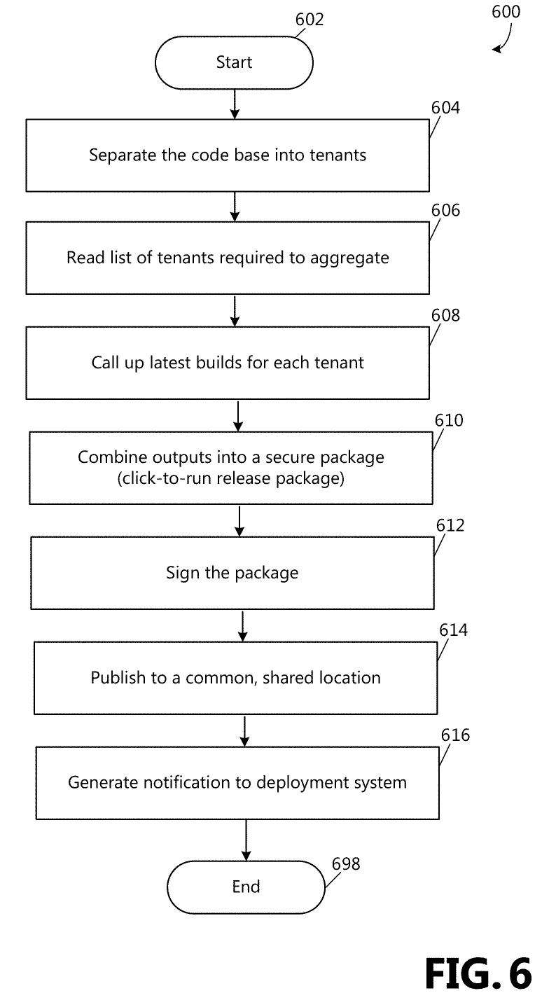

With reference now to FIG. 6, a flow chart showing general stages involved in an example method 600 for click-to-run aggregation is illustrated. Click-to-run aggregation method 600 is a distributed method that serves to significantly speed up building of code by splitting a monolithic codebase 202 into multiple tenants 204 which can be built on multiple machines. This is in contrast to the prior method of keeping the codebase monolithic and building the code on a single machine. Method 600 starts at OPERATION 602 and proceeds to OPERATION 604 where the monolithic codebase 202 is split up into multiple tenants 204 as described with respect to FIGS. 2-4. These tenants 204 are intermittently built, assigned a label, and a pointer is updated to the latest version of each tenant's build. Once the codebase is split into multiple tenants 204, at OPERATION 606 the method 600 reads a list of tenants 204 necessary to be aggregated together. Method 600 proceeds to OPERATION 608 and calls up the latest builds for each tenant 204 on the list.

Method 600 stamps a unique version number on each build and combines these tenant 204 builds into a secure package at OPERATION 610. This is known as a click-to-run release package. At OPERATION 612, the release package is signed, and at OPERATION 614 it is published to a common, shared location. Following publication, OPERATION 616 generates a notification to a deployment system that the click-to-run release package is ready to be deployed to end users. OPERATION 698 ends method 600.

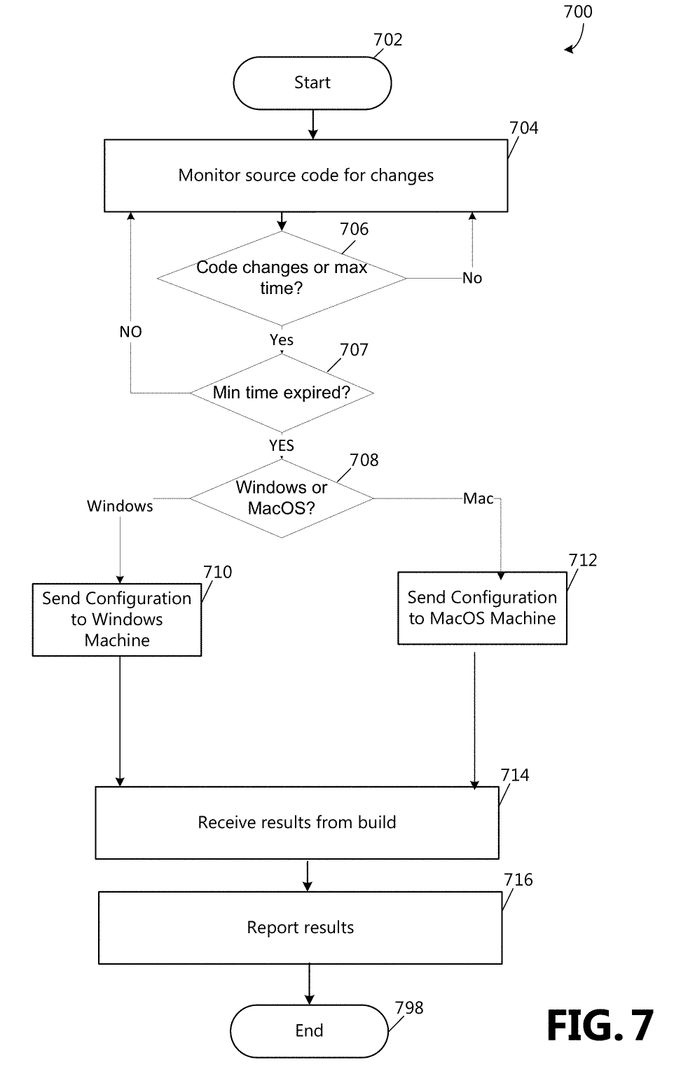

With reference now to FIG. 7, a flow chart showing general stages involved in an example method 700 for external system integration using a local build is illustrated. Certain code has to be built on particular machines. For example code for MACOS® products needs to be built on MACOS® machines; while builds for WINDOWS® products can be built on WINDOWS machines. While the discussion herein is with respect to MACOS® and WINDOWS® products, those skilled in the art after reading this disclosure would appreciate that a method 700 described herein can be used with code having build requirements on operating systems other than WINDOWS® and MACOS®, for example Linux builds on Linux machines. Method 700 serves to automate a process that in the past had to be manually executed and supervised, with manual transfer of code from machine to appropriate machine being the norm.

External system integration method 700 starts at OPERATION 702 and proceeds to OPERATION 704 which monitors the source code for any changes. At OPERATION 706, if there have been any changes to the source code, or if a schedule indicates a build needs to be run or if a maximum amount of time has expired since the last build, then method 700 proceeds to OPERATION 707. If no changes need to be run and there are no scheduled builds or a maximum amount of time has not expired, method 700 returns to OPERATION 704. At OPERATION 707, the method 700 checks to see if a minimum amount of time has expired since the last build. If not, the method 700 returns to OPERATION 704, but if so, the method 700 continues to OPERATION 708.

If there have been code changes or a scheduled build needs to run, at OPERATION 708, the method 700 determines whether a build needs to be run on a WINDOWS® machine or a MACOS® machine. If a build needs to be run on a WINDOWS® machine, method 700 proceeds to OPERATION 710. However, if a build needs to be run on a MACOS® machine, method 700 proceeds to OPERATION 712.

If it is desired that the build occur on a WINDOWS® machine, the configuration for the build on the WINDOWS® machine is sent to a WINDOWS® machine at OPERATION 710. If it is desired that the build occur on a MACOS® machine, the configuration for the build on the MACOS® machine is sent to a MACOS® machine at OPERATION 712. Following the build at either OPERATION 710 or OPERATION 712, the method 700 receives the results of the build at OPERATION 714. Build results may include, for example, success or failure. The method 700 proceeds to OPERATION 716 where the results are reported back to user 118. Results may be reported back in, for example, an email to user 118. The method ceases at OPERATION 798.

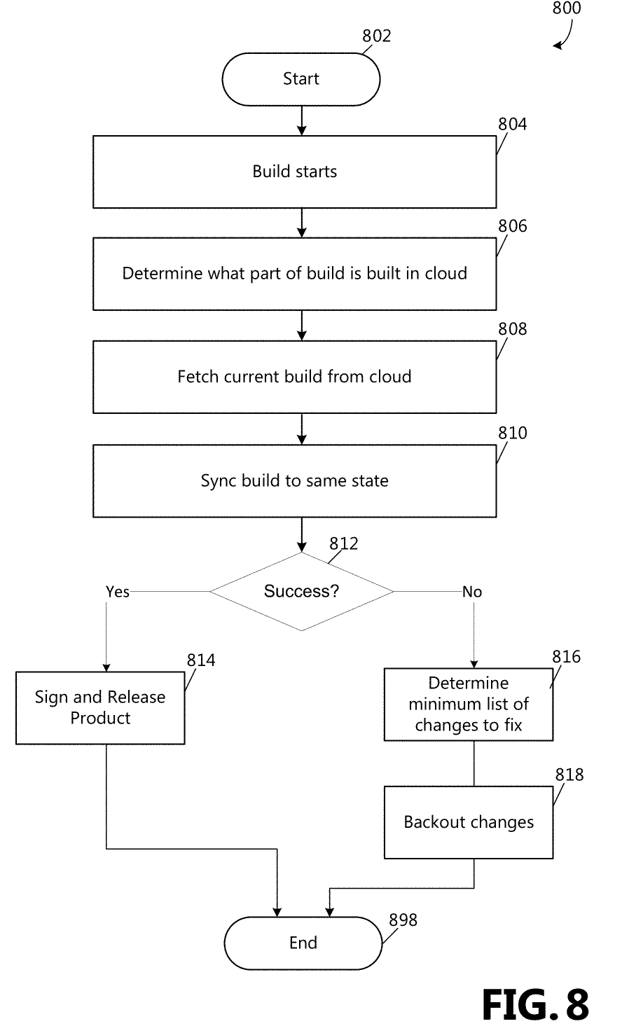

Turning to FIG. 8, a flow chart showing general stages involved in an example method 800 for external system integration using a cloud build is illustrated. External system integration using cloud build is similar to external system integration using local resources described with respect to FIG. 7, but rather than use local resources, one or more tenants 204 are built in the cloud. Method 800 significantly speeds build performance where tenants reside in a combination of the cloud and on local machines. The methods shown in FIG. 7 may be combined with the methods shown in FIG. 8 to enable a combination of locally building on WINDOWS® and MACOS® machines, as well as building in the cloud.

When a user 118 starts a cloud build, method 800 begins at OPERATION 802 and proceeds to OPERATION 804 where the build starts. At OPERATION 806, method 800 determines what part of the build, i.e., which tenants 204 or part of tenants, are in the cloud. Once that is determined, method 800 proceeds to OPERATION 808 where the current build for each tenant 204 or part of tenant 204 that resides in the cloud is fetched from the cloud. At OPERATION 810, method 800 determines the change that the build was synchronized to and uses that to synchronize the current system build to the same state.

Method 800 proceeds to OPERATION 812 where the success or failure of the build is examined. If successful, method 800 proceeds to OPERATION 814 and the product is signed and released. If unsuccessful, a minimum list of unsuccessful changes is determined by method 800 at OPERATION 816. At OPERATION 818, the unsuccessful changes are backed out. Method 800 ends at OPERATION 898.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 9-11 and the associated descriptions provide a discussion of a variety of operating environments in which examples are practiced. However, the devices and systems illustrated and discussed with respect to FIGS. 9-11 are for purposes of example and illustration and are not limiting of a vast number of computing device configurations that are utilized for practicing aspects, described herein.

FIG. 9 is a block diagram illustrating physical components (i.e., hardware) of a computing device 900 with which examples of the present disclosure may be practiced. In a basic configuration, the computing device 900 includes at least one processing unit 902 and a system memory 904. According to an aspect, depending on the configuration and type of computing device, the system memory 904 comprises, but is not limited to, volatile storage (e.g., random access memory), non-volatile storage (e.g., read-only memory), flash memory, or any combination of such memories. According to an aspect, the system memory 904 includes an operating system 905 and one or more program modules 906 suitable for running software applications 950. According to an aspect, the system memory 904 includes the cross-machine build scheduling system 106. The operating system 905, for example, is suitable for controlling the operation of the computing device 900. Furthermore, aspects are practiced in conjunction with a graphics library, other operating systems, or any other application program, and are not limited to any particular application or system. This basic configuration is illustrated in FIG. 9 by those components within a dashed line 908. According to an aspect, the computing device 900 has additional features or functionality. For example, according to an aspect, the computing device 900 includes additional data storage devices (removable and/or non-removable) such as, for example, magnetic disks, optical disks, or tape. Such additional storage is illustrated in FIG. 9 by a removable storage device 909 and a non-removable storage device 910.

As stated above, according to an aspect, a number of program modules and data files are stored in the system memory 904. While executing on the processing unit 902, the program modules 906 (e.g., cross-machine build scheduling system 106) perform processes including, but not limited to, one or more of the stages of the methods 400, 500, 600, 700, and 800 illustrated in FIGS. 4, 5, 6, 7, and 8. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 9 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 900 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 900 has one or more input device(s) 912 such as a keyboard, a mouse, a pen, a sound input device, a touch input device, etc. The output device(s) 914 such as a display, speakers, a printer, etc. are also included according to an aspect. The aforementioned devices are examples and others may be used. According to an aspect, the computing device 900 includes one or more communication connections 916 allowing communications with other computing devices 918. Examples of suitable communication connections 916 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (i.e., memory storage). According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. According to an aspect, any such computer storage media is part of the computing device 900. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

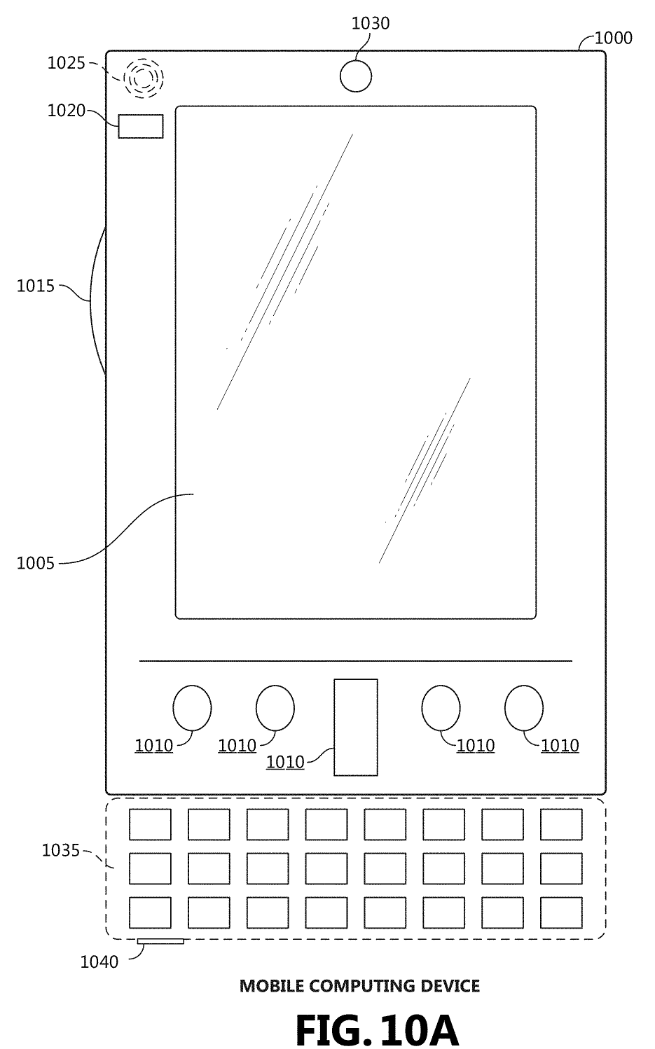

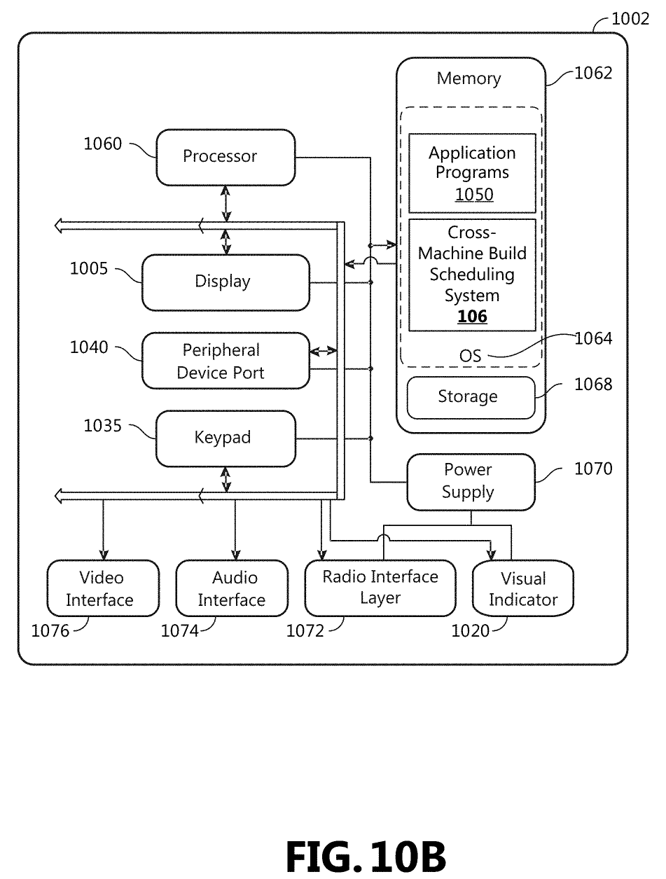

FIGS. 10A and 10B illustrate a mobile computing device 1000, for example, a mobile telephone, a smart phone, a tablet personal computer, a laptop computer, and the like, with which aspects may be practiced. With reference to FIG. 10A, an example of a mobile computing device 1000 for implementing the aspects is illustrated. In a basic configuration, the mobile computing device 1000 is a handheld computer having both input elements and output elements. The mobile computing device 1000 typically includes a display 1005 and one or more input buttons 1010 that allow the user to enter information into the mobile computing device 1000. According to an aspect, the display 1005 of the mobile computing device 1000 functions as an input device (e.g., a touch screen display). If included, an optional side input element 1015 allows further user input. According to an aspect, the side input element 1015 is a rotary switch, a button, or any other type of manual input element. In alternative examples, mobile computing device 1000 incorporates more or less input elements. For example, the display 1005 may not be a touch screen in some examples. In alternative examples, the mobile computing device 1000 is a portable phone system, such as a cellular phone. According to an aspect, the mobile computing device 1000 includes an optional keypad 1035. According to an aspect, the optional keypad 1035 is a physical keypad. According to another aspect, the optional keypad 1035 is a “soft” keypad generated on the touch screen display. In various aspects, the output elements include the display 1005 for showing a graphical user interface (GUI), a visual indicator 1020 (e.g., a light emitting diode), and/or an audio transducer 1025 (e.g., a speaker). In some examples, the mobile computing device 1000 incorporates a vibration transducer for providing the user with tactile feedback. In yet another example, the mobile computing device 1000 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 1000 incorporates peripheral device port 1040, such as an audio input (e.g., a microphone jack), an audio output (e.g., a headphone jack), and a video output (e.g., a HDMI port) for sending signals to or receiving signals from an external device.

FIG. 10B is a block diagram illustrating the architecture of one example of a mobile computing device. That is, the mobile computing device 1000 incorporates a system (i.e., an architecture) 1002 to implement some examples. In one example, the system 1002 is implemented as a “smart phone” capable of running one or more applications (e.g., browser, e-mail, calendaring, contact managers, messaging clients, games, and media clients/players). In some examples, the system 1002 is integrated as a computing device, such as an integrated personal digital assistant (PDA) and wireless phone.

According to an aspect, one or more application programs 1050 are loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. According to an aspect, the cross-machine build scheduling system 106 is loaded into memory 1062. The system 1002 also includes a non-volatile storage area 1068 within the memory 1062. The non-volatile storage area 1068 is used to store persistent information that should not be lost if the system 1002 is powered down. The application programs 1050 may use and store information in the non-volatile storage area 1068, such as e-mail or other messages used by an e-mail application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000.

According to an aspect, the system 1002 has a power supply 1070, which is implemented as one or more batteries. According to an aspect, the power supply 1070 further includes an external power source, such as an AC adapter or a powered docking cradle that supplements or recharges the batteries.

According to an aspect, the system 1002 includes a radio 1072 that performs the function of transmitting and receiving radio frequency communications. The radio 1072 facilitates wireless connectivity between the system 1002 and the “outside world,” via a communications carrier or service provider. Transmissions to and from the radio 1072 are conducted under control of the operating system 1064. In other words, communications received by the radio 1072 may be disseminated to the application programs 1050 via the operating system 1064, and vice versa.

According to an aspect, the visual indicator 1020 is used to provide visual notifications and/or an audio interface 1074 is used for producing audible notifications via the audio transducer 1025. In the illustrated example, the visual indicator 1020 is a light emitting diode (LED) and the audio transducer 1025 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 1025, the audio interface 1074 may also be coupled to a microphone to receive audible input, such as to facilitate a telephone conversation. According to an aspect, the system 1002 further includes a video interface 1076 that enables an operation of an on-board camera 1030 to record still images, video stream, and the like.

According to an aspect, a mobile computing device 1000 implementing the system 1002 has additional features or functionality. For example, the mobile computing device 1000 includes additional data storage devices (removable and/or non-removable) such as, magnetic disks, optical disks, or tape. Such additional storage is illustrated in FIG. 10B by the non-volatile storage area 1068.

According to an aspect, data/information generated or captured by the mobile computing device 1000 and stored via the system 1002 is stored locally on the mobile computing device 1000, as described above. According to another aspect, the data is stored on any number of storage media that is accessible by the device via the radio 1072 or via a wired connection between the mobile computing device 1000 and a separate computing device associated with the mobile computing device 1000, for example, a server computer in a distributed computing network, such as the Internet. As should be appreciated such data/information is accessible via the mobile computing device 1000 via the radio 1072 or via a distributed computing network. Similarly, according to an aspect, such data/information is readily transferred between computing devices for storage and use according to well-known data/information transfer and storage means, including electronic mail and collaborative data/information sharing systems.

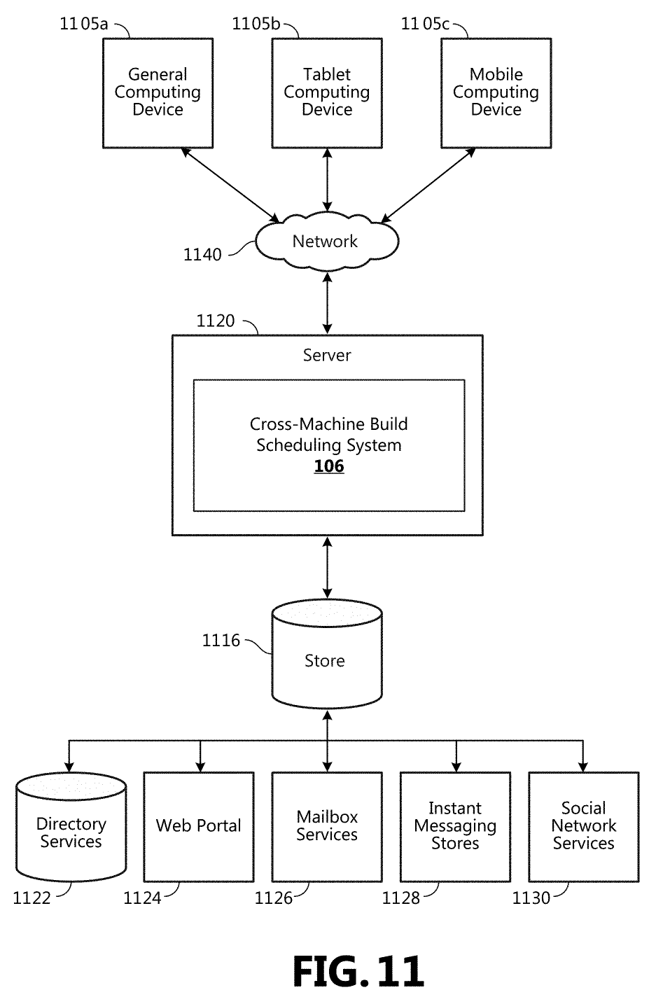

FIG. 11 illustrates one example of the architecture of a system for cross-machine build scheduling a codebase as described above. Content developed, interacted with, or edited in association with the cross-machine build scheduling system 106 is enabled to be stored in different communication channels or other storage types. For example, various documents may be stored using a directory service 1122, a web portal 1124, a mailbox service 1126, an instant messaging store 1128, or a social networking site 1130. The cross-machine build scheduling system 106 is operative to use any of these types of systems or the like for automatically managing and validating a codebase, as described herein. According to an aspect, a server 1120 provides the cross-machine build scheduling system 106 to clients 1105a,b,c. As one example, the server 1120 is a web server providing the cross-machine build scheduling system 106 over the web. The server 1120 provides the cross-machine build scheduling system 106 over the web to clients 1105 through a network 1140. By way of example, the client computing device is implemented and embodied in a personal computer 1105a, a tablet computing device 1105b or a mobile computing device 1105c (e.g., a smart phone), or other computing device. Any of these examples of the client computing device are operable to obtain content from the store 1116.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A system comprising a computing device, the computing device comprising:
a processing device; and
a computer readable data storage device storing instructions that, when executed by the processing device are operative to provide:
breaking a monolithic codebase into a plurality of tenants;
reading a file containing entries associated with one of the tenants;
examining a selected entry in the file to determine if the entry is requesting the execution of parallel loops, and if so, executing each loop of the parallel loops in parallel;
examining the selected entry in the file to determine if the entry is an independent loop, and if so, executing the independent loop; and
examining the selected entry in the file to determine if the entry is a dependent loop, and if so, holding execution of the dependent loop.

2. The system of claim 1 further comprising, releasing for execution the dependent loop once its pre-validation loop has successfully completed execution.

3. The system of claim 1, wherein the loop comprises a request to build the tenant.

4. The system of claim 1, wherein the loop comprises a request to debug the tenant.

5. The system of claim 1, wherein the loop comprises a request to test the tenant.

6. The system of claim 2, wherein the dependent loop uses a timestamp of the last successful iteration of its pre-validation loop to determine when to execute.

7. A method comprising:
separating a codebase into a plurality of tenants;
reading a list of tenants required to aggregate to form a product release;
calling up one or more latest builds of each tenant;
combining the latest builds into a secure package;
signing the secure package; and
publishing the secure package to a common, shared location.

8. The method of claim 7, further comprising, after publishing the secure package, generating a notification to a deployment system that the secure package is ready for deployment.

9. The method of claim 8, further comprising deploying the secure package to an end user.

10. A method comprising:
monitoring source code for changes;
when changes are found, determining an appropriate build machine by determining whether the changes require a build on a first machine with a first operating system or a second machine with a second operating system;
sending a configuration with the changed source code to the appropriate build machine;
receiving results from the appropriate build machine; and
reporting the results.

11. The method of claim 10, further comprising when a scheduled build time occurs, determining an appropriate build machine by determining whether the changes require a build on a first machine with a first operating system or a second machine with a second operating system;
sending a configuration with the changed source code to the appropriate build machine;
receiving results from the appropriate build machine; and
reporting the results.

12. The method of claim 10, wherein the results are reported in the form of an email to a user.

13. The method of claim 10, wherein the first operating system is MACOS®.

14. The method of claim 10, wherein the second operating system is WINDOWS®.

15. A method comprising:
starting a build;
determining what portions of the build reside in the cloud and what portions of the build reside locally;
fetching a current build from the cloud for those portions of the build residing in the cloud; and
synchronizing each of the fetched, current builds with each of the builds that reside locally to form a product build.

16. The method of claim 15, further comprising determining if the product build is successful.

17. The method of claim 16, further comprising, when the product build is successful, signing the product build.

18. The method of claim 17, further comprising releasing the product build.

19. The method of claim 16, further comprising, when the product build is unsuccessful, determining a minimum list of changes to fix the build.

20. The method of claim 19, further comprising backing out the minimum list of changes.
